(19) United States
(12) Patent Application Publication
(10) Pub. No.: US 2013/0198760 A1
(43) Pub. Date: Aug. 1, 2013

(54) AUTOMATIC DEPENDENT TASK LAUNCH

(71) Applicants: Philip Alexander CUADRA, San Francisco, CA (US); Lacky V. Shah, Los Altos Hills, CA (US); Timothy John Purcell, Provo, UT (US); Gerald F. Luiz, Los Gatos, CA (US); Jerome F. Duluk, JR., Palo Alto, CA (US)

(72) Inventors: Philip Alexander CUADRA, San Francisco, CA (US); Lacky V. Shah, Los Altos Hills, CA (US); Timothy John Purcell, Provo, UT (US); Gerald F. Luiz, Los Gatos, CA (US); Jerome F. Duluk, JR., Palo Alto, CA (US)

(21) Appl. No.: 13/360,581

(22) Filed: Jan. 27, 2012

(51) Int. Cl. G06F 9/46

(52) U.S. Cl. 718/106

(57) ABSTRACT

One embodiment of the present invention sets forth a technique for automatic launching of a dependent task when execution of a first task completes. Automatically launching the dependent task reduces the latency incurred during the transition from the first task to the dependent task. Information associated with the dependent task is encoded as part of the metadata for the first task. When execution of the first task completes a task scheduling unit is notified and the dependent task is launched without requiring any release or acquisition of a semaphore. The information associated with the dependent task includes an enable flag and a pointer to the dependent task. Once the dependent task is launched, the first task is marked as complete so that memory storing the metadata for the first task may be reused to store metadata for a new task.

### BACKGROUND OF THE INVENTION

1. Field of the Invention

The present invention generally relates to program execution and more specifically to automatic launching of a dependent task when execution of a first task completes.

2. Description of the Related Art

Execution of a dependent task typically requires coordination through the use of semaphores, where a first task releases a semaphore that the dependent task then acquires. The use of semaphores ensures that execution of the first task is complete before execution of the dependent task begins. Because the dependent task is dependent on values or data that is computed by the first task, the dependent task must wait until execution of the first task is complete.

Releasing and acquiring the semaphore is performed through memory reads and writes. The first task writes memory to release the semaphore and the dependent task reads the memory to acquire the semaphore. Once the semaphore is acquired by the dependent task, the dependent task is then input to the processor and execution of the dependent task may then be launched. The semaphore release and acquire transactions introduce a significant amount of latency, e.g., number of clock cycles, between when execution of the first task completes and execution of the dependent task may start. The semaphore release and acquire operations also necessitate one memory write and typically several memory reads. The memory write and reads consume memory bandwidth and may reduce processing performance when the available memory bandwidth is limited.

Accordingly, what is needed in the art is a system and method for improved launching of dependent tasks during multi-threaded execution. In particular, it is desirable to reduce the latency incurred to transition between execution of a first task to execution of a dependent task when execution of the first task is complete.

### SUMMARY OF THE INVENTION

A system and method for automatic launching of a dependent task when execution of a first task completes reduces the latency incurred during the transition from the first task to the dependent task. Information associated with the dependent task is encoded as part of the metadata for the first task. When execution of the first task completes a task scheduling unit is notified and the dependent task is launched without requiring any release or acquisition of a semaphore. The information associated with the dependent task includes an enable flag and a pointer to the dependent task. Once the dependent task is launched, the first task is marked as complete so that memory storing the metadata for the first task may be reused to store metadata for a new task.

Various embodiments of a method of the invention for automatically launching a dependent task include receiving a notification that a first processing task has completed execution in a multi-threaded system. A dependent task enable flag stored in first task metadata that encodes the first processing task is read. The dependent task enable flag is written prior to execution of the first processing task. When execution of the first processing task is complete, the dependent task enable flag which indicates that a dependent task should be executed is determined to be set and the dependent task is scheduled for execution in the multi-threaded system.

Various embodiments of the invention include a multi-threaded system configured to automatically launch a dependent task. The multi-threaded system comprises a memory configured to store first task metadata that encodes a first processing task, a general processing cluster, and a task management unit that is coupled to the general processing cluster. The general processing cluster is configured to execute the first processing task and generate a notification when execution of the first processing task completes. The task management unit is configured to receive the notification that the first processing task has completed execution, read a dependent task enable flag that is stored in the first task metadata, where the dependent task enable flag was written prior to execution of the first processing task, determine that the dependent task enable flag indicates that a dependent task should be executed when execution of the first processing task is complete, and schedule the dependent task for execution by the general processing cluster.

Execution of the dependent task is launched automatically when the first task completes execution, reducing the latency incurred during the transition from the first task to the dependent task compared with using a semaphore. At the time when the first task is encoded the first task includes the information associated with the dependent task. Therefore, the information is already known and available when the first task is executed. Additionally, the dependent task may include information associated with a second dependent task that will be automatically executed following execution of the dependent task.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention;

FIG. 2 is a block diagram of a parallel processing subsystem for the computer system of FIG. 1, according to one embodiment of the invention;

FIG. 3A is a block diagram of the Task/Work Unit of FIG. 2, according to one embodiment of the invention;

FIG. 3B is a block diagram of a general processing cluster within one of the parallel processing units of FIG. 2, according to one embodiment of the present invention;

FIG. 4A is a conceptual diagram of the contents of a TMD of FIG. 3A, according to one embodiment of the invention;

FIG. 4B illustrates an original task and two dependent tasks, according to one embodiment of the invention; and

FIG. 5 illustrates method for automatically launching a dependent task, according to one embodiment of the invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

System Overview

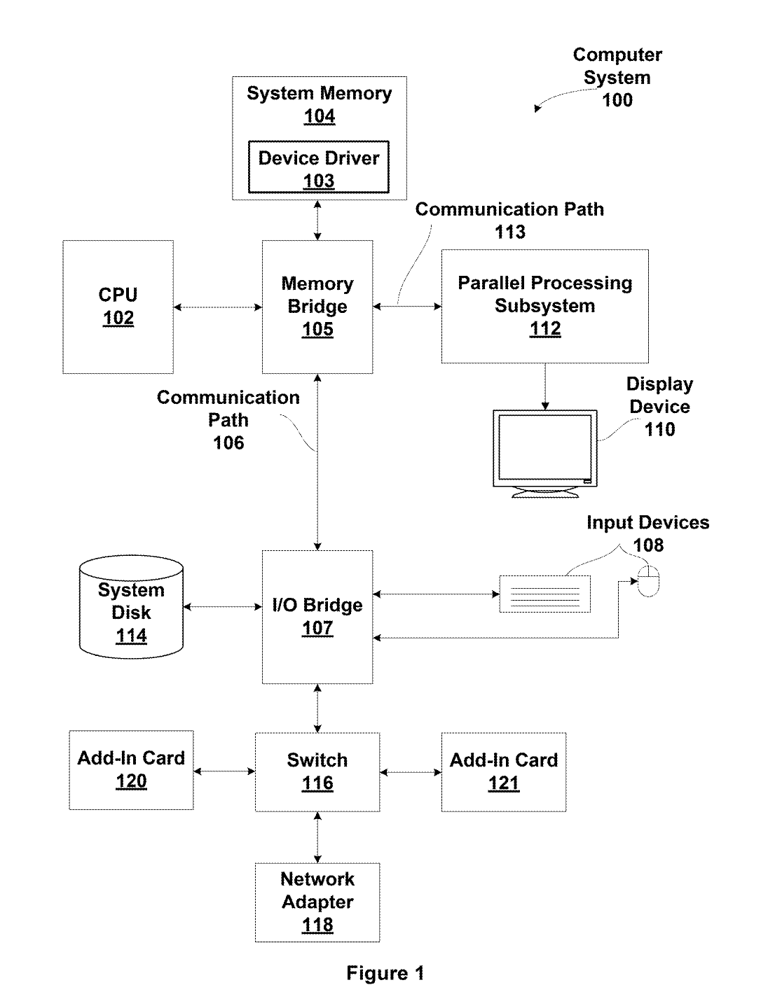

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

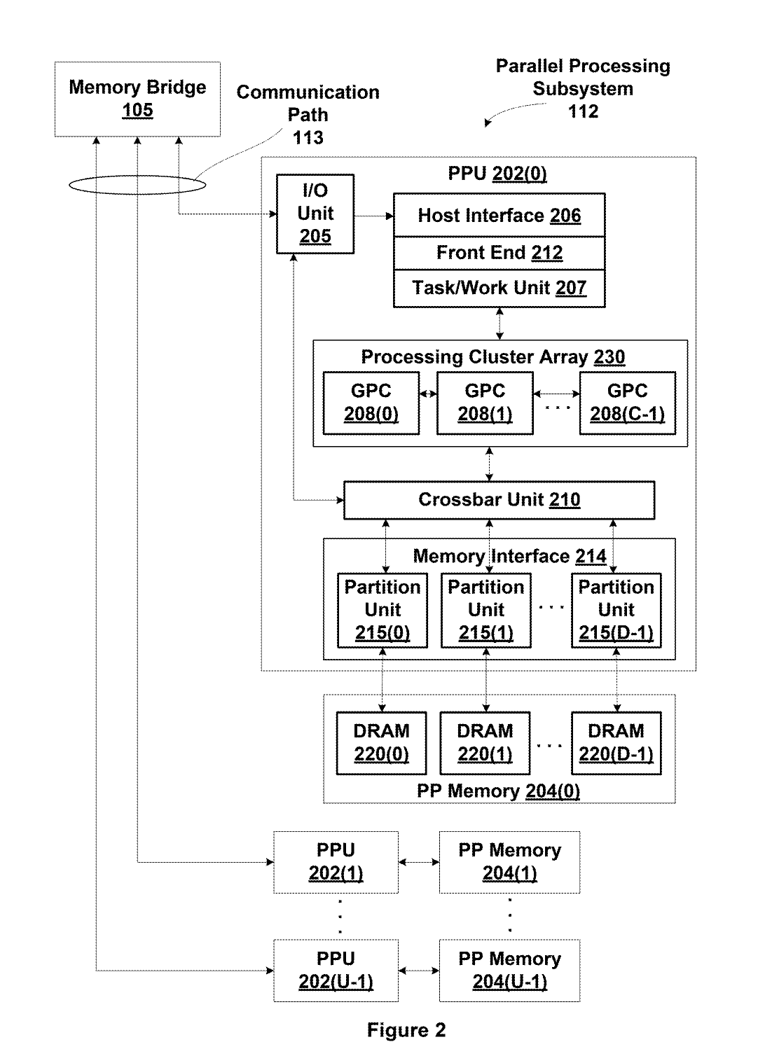

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer to control scheduling of the different pushbuffers.

Referring back now to FIG. 2B, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-EXPRESS link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to compute processing tasks that are encoded as task metadata (TMD) and stored in memory. The task pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail fo the linked list, thereby providing another level of control over priority.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

Multiple Concurrent Task Scheduling

Multiple processing tasks may be executed concurrently on the GPCs 208 and a processing task may generate one or more “child” processing tasks during execution. The task/work unit 207 receives the tasks and dynamically schedules the processing tasks and child processing tasks for execution by the GPCs 208. The task/work unit 207 is also configured to automatically schedule dependent tasks for execution when a processing task that specifies the particular dependent task has completed execution. Dependent tasks differ from child tasks in that the dependent tasks are not generated during execution of a parent processing task. Instead, a dependent task is defined when the parent task, e.g., task that specifies the dependent task, is defined and is therefore, known and available by the time that the parent task begins execution.

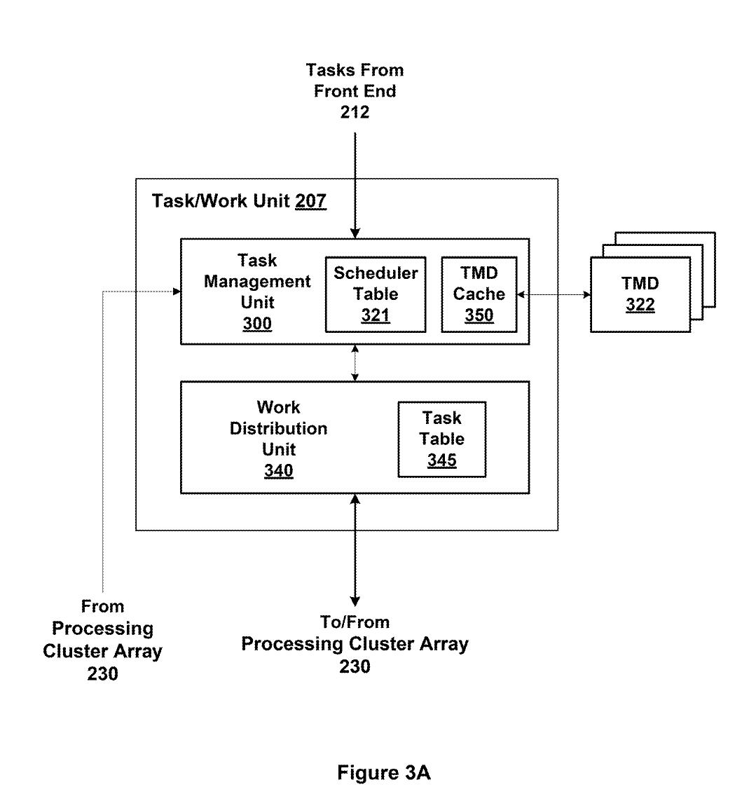

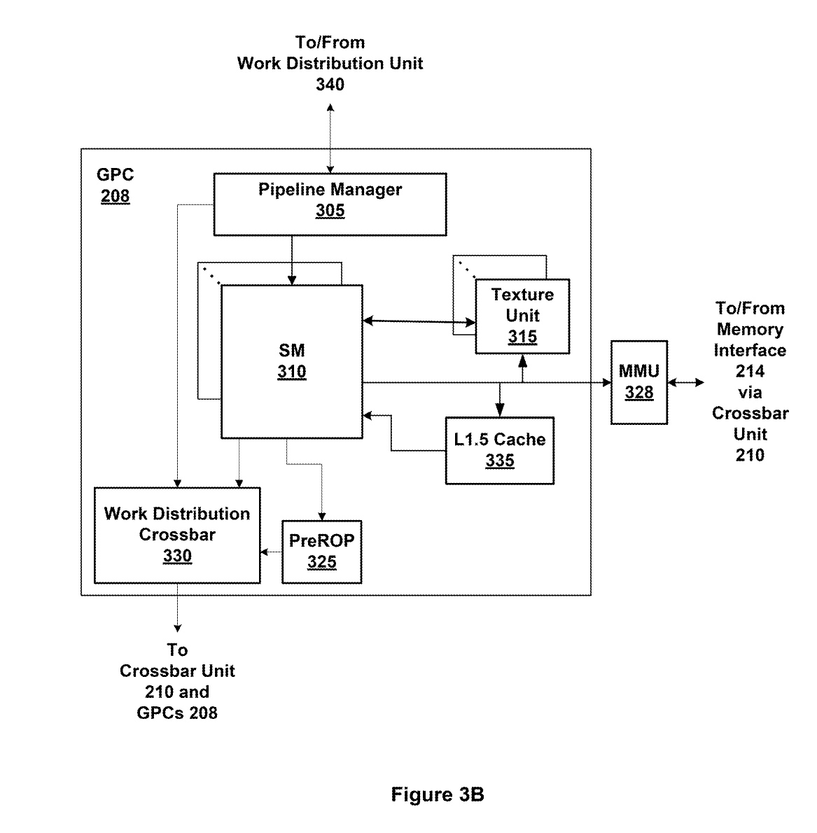

FIG. 3A is a block diagram of the task/work unit 207 of FIG. 2, according to one embodiment of the present invention. The task/work unit 207 includes a task management unit 300 and the work distribution unit 340. The task management unit 300 organizes tasks to be scheduled based on execution priority levels. For each priority level, the task management unit 300 stores a list of task pointers to the TMDs 322 corresponding to the tasks in the scheduler table 321, where the list can be implemented with a linked list, and hereinafter a linked list is assumed. The TMDs 322 are metadata representing a task, such as configuration data and state information needed to execute the task. The TMD cache 350 stores at least portions of one or more TMDs 322. The TMDs 322 stored in the TMD cache 350 may be stored in the PP memory 204 or system memory 104 along with other TMDs of which portions are not also stored in the TMD cache 350. The rate at which the task management unit 300 accepts tasks and stores the tasks in the scheduler table 321 is decoupled from the rate at which the task management unit 300 schedules tasks for execution, enabling the task management unit 300 to schedule tasks based on priority information or using other techniques.

The work distribution unit 340 includes a task table 345 with slots that may each be occupied by the TMD 322 for a task that is being executed. The task management unit 300 may schedule tasks for execution when there is a free slot in the task table 345. When there is not a free slot, a higher priority task that does not occupy a slot may evict a lower priority task that does occupy a slot. When a task is evicted, the task is stopped, and if execution the task is not complete, the task is added to a linked list in the scheduler table 321. When a child processing task is generated, the child processing task is added to a linked list in the scheduler table 321. Similarly, when execution of a dependent task is launched, the dependent task is added to the linked list in the scheduler table 321. A task is removed from a slot when the task is evicted.

Each TMD 322 may be a large structure, e.g., 256 Bytes or more, that is typically stored in PP memory 204. Due to the large size, the TMDs 322 are expensive to access in terms of bandwidth. Therefore, the TMD cache 350 stores only the (relatively small) portion of the TMD 322 that is needed by the task management unit 300 for scheduling when a task is launched. The remainder of the TMD 322 may be fetched from PP memory 204 when the task is scheduled, i.e., transferred to the work distribution unit 340.

The TMDs 322 are written under software control, and, when a compute task completes execution, the TMD associated with the completed compute task may be recycled to store information for a different compute task. Because a TMD 322 may be stored in the TMD cache 350, the entries storing information for the completed compute task should be flushed from the TMD cache 350. The flushing operation is complicated because the writing of the information for the new compute task is decoupled from a write-back of information stored in the TMD cache 350 to the TMD 322 resulting from the flush. In particular, the information for the new task is written to the TMD 322 and then the TMD 322 is output to the front end 212 as part of a push buffer. Thus, the software does not receive a confirmation that the TMD cache 350 has been flushed, so that writing of the TMD 322 can be delayed to be certain that the information for the new task is not overwritten during the flush. Because the cache write-back for the flush may overwrite information stored in the TMD 322 for the new task, a “hardware-only” portion of each TMD 322 is set aside for access only by the task management unit 300. The remainder of the TMD 322 may be accessed by software and the task management unit 300. The portion of the TMD 322 that can be accessed by software is typically filled by software to initiate a task. The TMD 322 is then accessed by the task management unit 300 and other processing units in the GPC 208 during scheduling and execution of the task. When information for a new compute task is written to a TMD 322, the command launching the TMD 322 may specify whether to copy bits into the hardware-only portion of the TMD 322 the first time the TMD 322 is loaded into the TMD cache 350. This ensures that the TMD 322 will correctly only store information for the new compute task since any information for the completed compute task would have only been stored in the hardware-only portion of the TMD 322.

When a TMD 322 includes information for a dependent TMD, the dependent TMD is automatically launched when execution of the TMD 322 is complete. The information for the dependent TMD includes a flag indicating whether bits should be copied into the hardware-only portion of the dependent TMD when the TMD is loaded in to the TMD cache 350 and launched.

Task Processing Overview

FIG. 3B is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons of ordinary skill in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

In one embodiment, each GPC 208 includes a number M of SMs 310, where M≧1, each SM 310 configured to process one or more thread groups. Also, each SM 310 advantageously includes an identical set of functional execution units that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains a level one (L1) cache or uses space in a corresponding L1 cache outside of the SM 310 that is used to perform load and store operations. Each SM 310 also has access to level two (L2) caches that are shared among all GPCs 208 and may be used to transfer data between threads. Finally, SMs 310 also have access to off-chip “global” memory, which can include, e.g., parallel processing memory 204 and/or system memory 104. It is to be understood that any memory external to PPU 202 may be used as global memory. Additionally, a level one-point-five (L1.5) cache 335 may be included within the GPC 208, configured to receive and hold data fetched from memory via memory interface 214 requested by SM 310, including instructions, uniform data, and constant data, and provide the requested data to SM 310. Embodiments having multiple SMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches, and so on.

Persons of ordinary skill in the art will understand that the architecture described in FIGS. 1, 2, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during its execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

Compute Task Metadata

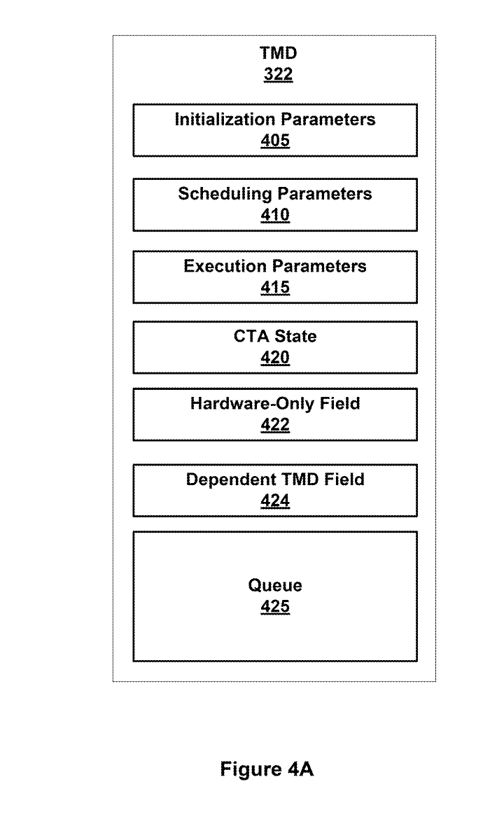

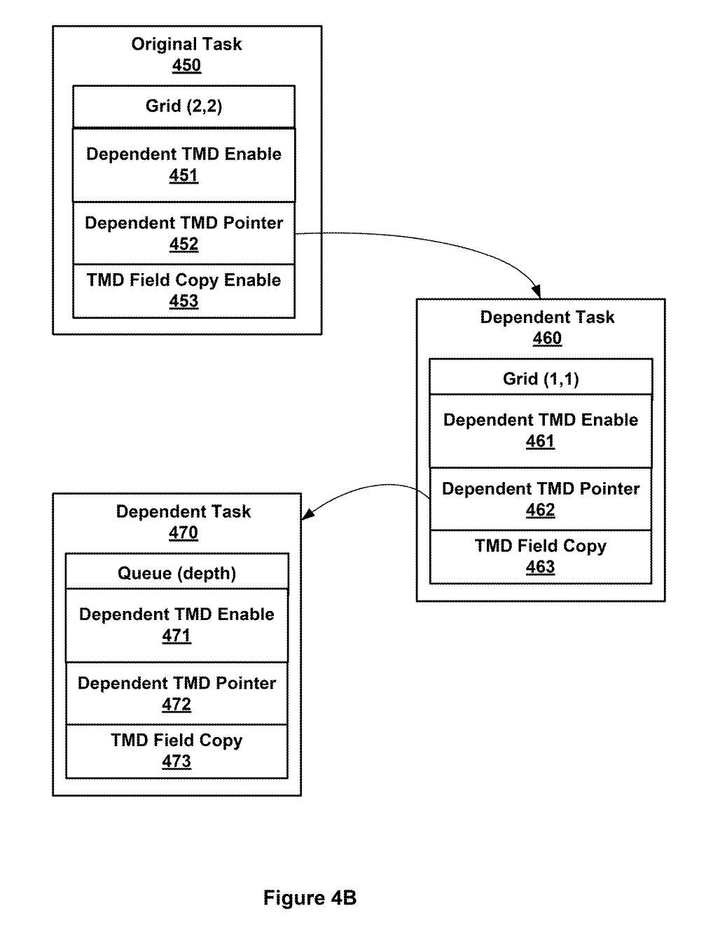

FIG. 4A is a conceptual diagram of the contents of a TMD 322 that is stored in PP memory 204, according to one embodiment of the invention. The TMD 322 is configured to store initialization parameters 405, scheduling parameters 410, execution parameters 415, CTA state 420, a hardware-only field 422, and a queue 425. The hardware-only field 422 stores the hardware-only portion of the TMD 322, which comprises one or more hardware-only parameters. State that is common to all TMDs 322 is not included in each TMD 322. Because a TMD 322 is a data structure that is stored in PP memory 204, a compute program running on the CPU 102 or PPU 112 can create a TMD 322 structure in memory and then submit the TMD 322 for execution by sending a task pointer to the TMD 322 to the task/work unit 207.

The initialization parameters 405 are used to configure the GPCs 208 when the TMD 322 is launched and may include the starting program address and size of the queue 425. Note that the queue 425 may be stored separately from the TMD 322 in memory in which case the TMD 322 includes a pointer to the queue 425 (queue pointer) in place of the actual queue 425.

The initialization parameters 405 may also include bits to indicate whether various caches, e.g., a texture header cache, a texture sampler cache, a texture data cache, data cache, constant cache, and the like, are invalidated when the TMD 322 is launched. Initialization parameters 405 may also include dimensions of a CTA in threads, a TMD version number, an instruction set version number, dimensions of a grid in terms of CTA width, height, and depth, memory bank mapping parameters, depth of a call stack as seen by an application program, and a size of the call-return stack for the TMD 322.

The scheduling parameters 410 control how the task/work unit 207 schedules the TMD 322 for execution. The scheduling parameters 410 may include a bit indicating whether the TMD 322 is a queue TMD or a grid TMD. If the TMD 322 is a grid TMD, then the queue feature of the TMD 322 that allows for additional data to be queued after the TMD 322 is launched is unused, and execution of the TMD 322 causes a fixed number of CTAs to be launched and executed to process the fixed amount of data. The number of CTAs is specified as the product of the grid width, height, and depth. The queue 425 is replaced with a queue pointer to the data that will be processed by the CTAs executing the program specified by the TMD 322.

If the TMD 322 is a queue TMD, then the queue feature of the TMD 322 is used, meaning that data are stored in the queue 425, as queue entries. Queue entries are input data to CTAs of the TMD 322. The queue entries may also represent child tasks that are generated by another TMD 322 during execution of a thread, thereby providing nested parallelism. Typically, execution of the thread, or CTA that includes the thread, is suspended until execution of the child task completes. The queue 425 may be implemented as a circular queue so that the total amount of data is not limited to the size of the queue 425. As previously described, the queue 425 may be stored separately from the TMD 322 and the TMD 322 may store a queue pointer to the queue 425. Advantageously, queue entries for the child task may be written to the queue 425 while the TMD 322 representing the child task is executing.

A variable number of CTAs are executed for a queue TMD, where the number of CTAs depends on the number of entries written to the queue 425 of the queue TMD. The scheduling parameters 410 for a queue TMD also include the number of entries (N) of queue 425 that are processed by each CTA. When N entries are added to the queue 425, one CTA is launched for the TMD 322. The task/work unit 207 may construct a directed graph of processes, where each process is a TMD 322 with a queue. The number of CTAs to be executed for each TMD 322 may be determined based on the value of N for each TMD 322 and the number of entries that have been written in the queue 425.

The scheduling parameters 410 of a queue TMD may also comprise a coalesce waiting time parameter that sets the amount of time that is waited before a CTA is run with less than N queue entries. The coalesce waiting time parameter is needed when the queue is almost empty, but an insufficient number of queue entries is present, which can arise when the total number of queue entries over the course of execution is not evenly divisible by N. The coalesce waiting time parameter is also needed for the case of producer-consumer queues, in order to avoid deadlock. In the case of a CTA being executed with fewer than N entries, the number of queue entries is passed as a parameter to the TMD's program, so that the number of entries can be taken into account during execution.

Alternate embodiments may have different structures for a grid TMD and a queue TMD, or implement either grid TMDs or queue TMDs. The scheduling parameters 410 of the TMD 322 may include a bit indicating whether scheduling the dependent TMD also causes TMD fields to be copied to the hardware-only field 422. The scheduling parameters 410 may also include the TMD group ID, a bit to indicate where the TMD 322 is added to a linked list (head or tail), and a pointer to the next TMD 322 in the TMD group. The scheduling parameters 410 may also include masks that enable/disable specific streaming multiprocessors within the GPCs 208.

A TMD 322 may include a task pointer to a dependent TMD that is automatically launched when the TMD 322 completes. The dependent TMD field 424 includes an enable flag that is set to indicate that the dependent TMD should be launched for execution when execution of the original TMD 322 is complete. The task pointer to the dependent TMD is also stored in the dependent TMD field 424. In one embodiment, the task pointer is a number of most significant bits of a virtual address, e.g., 32 bits of a 40-bit virtual address of the dependent TMD. The dependent TMD field 424 may also store an indication of the type of TMD for the dependent TMD, e.g., grid or queue TMD. Finally, the dependent TMD field may also include a flag indicating that data should be copied to the hardware-only field of the dependent TMD when the dependent TMD is launched (or loaded into the TMD cache 350).

Using a dependent TMD to launch a task automatically after execution of an original TMD 322 is complete is advantageous because the latency between when the execution of the original TMD 322 completes and when the dependent TMD begins execution is low. Alternatively, semaphores may be executed by the TMDs 322 to ensure that dependencies between the different TMDs 322 and the CPU 102 are met.

For example, the execution of a second TMD 322 may depend on a first TMD 322 completing, so the first TMD 322 generates a semaphore release, and the second TMD 322 executes after the corresponding semaphore acquire succeeds. In some embodiments, the semaphore acquire is performed in the host interface 206 or the front end 212. The execution parameters 415 for a TMD 322 may store a plurality of semaphore releases, including the type of memory barrier, address of the semaphore data structure in memory, size of the semaphore data structure, payload, and enable, type, and format of a reduction operation. The data structure of the semaphore may be stored in the execution parameters 415 or may be stored outside of the TMD 322. However, performing the semaphore operations instead of using a dependent TMD to ensure that two TMDs 322 are executed serially results in a higher latency to transition from the first TMD 322 to the second TMD 322.

Automatic Dependent Task Launch

FIG. 4B illustrates an original task 450 and two dependent tasks 460 and 470, according to one embodiment of the invention. The original task 450 is received by the task/work unit 207 via the front end 212 and is included in a pushbuffer. As previously described, a TMD 322 encapsulates the metadata for a processing task, including grid dimensions. The grid dimensions (n,m), where n and m are integers, specify the number of CTAs that are executed to process the task. For example, grid dimensions 1,1 specify a single CTA and grid dimensions 2,1 or 1,2 specify two CTAs. Grids may have more than two dimensions, and all dimension sizes are specified in the TMD 322, assuming that the TMD 322 is a grid TMD.

The original task 450 is a grid TMD that specifies a grid(2,2) so that four CTAs will execute the data and program specified by the original task 450. The dependent TMD field in the original task 450 includes a dependent TMD enable 451, a dependent TMD pointer 452, and a TMD field copy enable 453. The dependent TMD enable 451 is set to TRUE, indicating the dependent task 460 should be launched when execution of the original task 450 is complete. The dependent TMD pointer 452 points to the dependent task 460 and the TMD field copy enable 453 is also set to TRUE, indicating that dependent TMD data should be copied to the hardware-only region of the dependent task 460.

The dependent task 460 is also a grid TMD, but unlike the original task 450, the dependent task 460 specifies a grid(1,1) so that only one CTA will execute the data and program specified by the dependent task 460. The dependent TMD field in the dependent task 460 includes a dependent TMD enable 461, a dependent TMD pointer 462, and a TMD field copy enable 463. The dependent TMD enable 461 is set to TRUE, indicating the dependent task 470 should be launched when execution of the dependent task 460 is complete. The dependent TMD pointer 462 points to the dependent task 470 and the TMD field copy enable 463 is set to FALSE, indicating that no dependent TMD data should be copied to the hardware-only region of the dependent task 470.

The dependent task 470 is a queue TMD. The dependent TMD field in the dependent task 470 includes a dependent TMD enable 471, a dependent TMD pointer 472, and a TMD field copy enable 473. The dependent TMD enable 471 is set to FALSE, indicating no dependent task should be launched when execution of the dependent task 470 is complete. Because the dependent TMD enable 471 is FALSE, the dependent TMD pointer 462 and the TMD field copy enable 463 are ignored.

Unlike the original task 450 which is specified in a pushbuffer, the dependent task 460 and 470 do not appear in the pushbuffer. Instead TMDs encoding the dependent tasks 460 and 470 are written to memory before the TMD 322 encoding the original task 450 is executed and information for executing the dependent tasks 460 and 470 is encoded in the dependent TMD fields of the original task 450 and the dependent task 460, respectively.

Dependent tasks 460 and 470 may be used to perform batch-type of processing functions that do not need to be or should not be performed by each thread of a CTA that executes the original task 450. In particular, while the original task 450 is executed by four CTAs, the dependent task 460 is executed by only a single CTA. The frequency of execution of the dependent task 460 relative to the original task 450 can be controlled by specifying the relative grid sizes of the respective TMDs. In one embodiment, the dependent task 460 or 470 may configured to perform memory defragmentation, memory allocation, or memory deallocation operations. In another embodiment dependent task 460 or 470 may be a scheduler task that is configured to have a high priority level. Only a single scheduler CTA is executed at a time and the scheduler task is responsible for determining when a grid has completed execution and for initiating launches of continuation tasks.

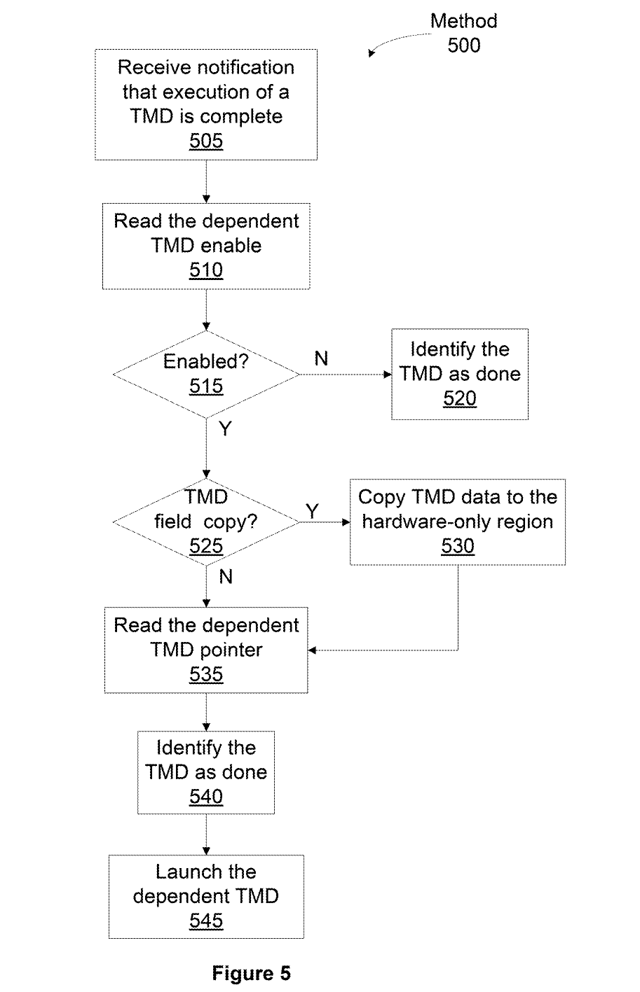

FIG. 5 illustrates method 500 for automatically launching a dependent task, according to one embodiment of the invention. Although the method steps are described in conjunction with the systems of FIGS. 1, 2, 3A, and 3B, persons skilled in the art will understand that any system configured to perform the method steps, in any order, is within the scope of the inventions.

At step 505 a notification from the processing cluster array 230 that a first processing task encoded as a TMD 322 has completed execution is received by the task management unit 300. At step 510 the task management unit 300 reads the dependent task enable flag that is stored in task metadata for the first task. Importantly, the dependent task enable flag and the TMD 322 encoding the dependent task was encoded prior to execution of the first task and that the dependent task is not specified in a pushbuffer.

At step 515 the task management unit 300 determines whether the dependent task enable flag indicates that a dependent task should be executed when execution of the first task is complete, i.e., whether the dependent TMD enable is set to TRUE. If, at step 515, a dependent task is not enabled, then at step 520 the original TMD is identified as done. Otherwise, at step 525 the task management unit 300 determines whether TMD data for the dependent task should be copied to a hardware-only region of the dependent TMD, i.e, if the TMD field copy enable is set TRUE.

If, at step 525 the task management unit 300 determines that the TMD field copy enable is set TRUE, then at step 530, the task management unit 300 copies the bits from the portion of the dependent TMD that is not hardware-only to the portion of the entry storing the hardware-only portion of the dependent TMD before proceeding to step 535. Copying the bits from the portion of the dependent TMD that is not hardware-only to the portion of the entry storing the hardware-only ensures that the task management unit 300 is able to access fields of the TMD 322 that are needed by the task management unit 300.

If, at step 525 the task management unit 300 determines that the TMD field copy enable is set FALSE, then at at step 540 the task management unit 300 identifies the original TMD as being done with execution. At step 545 the task management unit 300 launches the dependent TMD that encodes the dependent task for execution by the processing cluster array 230 by adding the dependent TMD to the scheduler table 321.

Because the dependent task is automatically launched for execution when the original task completes execution, the latency incurred during the transition from the original task to the dependent task is reduced compared with using a semaphore. At the time when the original task is encoded the original task includes the information associated with the dependent task. Therefore, the information is already known and available when the original task is executed. Additionally, the dependent task may include information associated with a second dependent task that will be automatically executed following execution of the dependent task. Therefore, the execution of multiple processing tasks may be efficiently completed. Additionally, the frequency of execution of the dependent task relative to the original task may be controlled so that the dependent task is only executed by a single CTA when the original task is executed by multiple CTAs. Conversely, the dependent task is only executed by multiple CTAs when the original task is executed by only a single CTA.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method of automatically launching a dependent task, the method comprising:
receiving a notification that a first processing task has completed execution in a multi-threaded system;
reading a dependent task enable flag that is stored in first task metadata that encodes the first processing task, wherein the dependent task enable flag is written prior to execution of the first processing task;
determining that the dependent task enable flag indicates that a dependent task should be executed when execution of the first processing task is complete; and
scheduling the dependent task for execution in the multi-threaded system.

2. The method of claim 1, further comprising reading a pointer to dependent task metadata that encodes the dependent task.

3. The method of claim 2, wherein the pointer to the dependent task metadata is included in the first task metadata.

4. The method of claim 2, wherein the pointer to the dependent task metadata is written prior to execution of the first processing task.

5. The method of claim 2, further comprising determining if a copy to a hardware-only region of the dependent task metadata is enabled.

6. The method of claim 5, further comprising copying data in a first region of the dependent task metadata to a hardware-only region of the dependent task metadata when the copy to the hardware-only region of the dependent task metadata is enabled.

7. The method of claim 2, further comprising, after the reading of the pointer, identifying the first processing task as having been completed.

8. The method of claim 1, wherein a task type of the dependent task is included in the first task metadata.

9. The method of claim 1, wherein dependent task metadata that encodes the dependent task indicates that the dependent task specifies a second dependent task.

10. The method of claim 1, wherein the dependent task is configured to perform a task scheduling function.

11. The method of claim 1, wherein the dependent task is configured to execute once for all executions of the first processing task.

12. The method of claim 1, wherein the dependent task is configured to execute multiple times for each execution of the first processing task.

13. A multi-threaded system configured to automatically launch a dependent task, comprising:
a memory configured to store first task metadata that encodes a first processing task;
a general processing cluster configured to execute the first processing task and generate a notification when execution of the first processing task completes;
a task management unit coupled to the general processing cluster and configured to:
receive the notification that the first processing task has completed execution;
read a dependent task enable flag that is stored in the first task metadata, wherein the dependent task enable flag was written prior to execution of the first processing task;
determine that the dependent task enable flag indicates that a dependent task should be executed when execution of the first processing task is complete; and
schedule the dependent task for execution by the general processing cluster.

14. The multi-threaded system of claim 13, wherein the task management unit is further configured to read a pointer to dependent task metadata stored in the memory that encodes the dependent task.

15. The multi-threaded system of claim 14, wherein the pointer to the dependent task metadata is included in the first task metadata.

16. The multi-threaded system of claim 14, wherein the task management unit is further configured to determine if a copy to a hardware-only region of the dependent task metadata is enabled.

17. The multi-threaded system of claim 16, wherein the task management unit is further configured to copy data in a first region of the dependent task metadata to a hardware-only region of the dependent task metadata when the copy to the hardware-only region of the dependent task metadata is enabled.

18. The multi-threaded system of claim 14, wherein the task management unit is further configured to, after the reading of the pointer, identify the first processing task as having been completed.

19. The multi-threaded system of claim 13, wherein a task type of the dependent task is included in the first task metadata.

20. The multi-threaded system of claim 13, wherein dependent task metadata that encodes the dependent task indicates that the dependent task specifies a second dependent task.

21. A non-transitory computer-readable storage medium storing instructions that, when executed by a processor, cause the processor to automatically launch a dependent task, by performing the steps of:
receiving a notification that a first processing task has completed execution in a multi-threaded system;
reading a dependent task enable flag that is stored in first task metadata that encodes the first processing task, wherein the dependent task enable flag was written prior to execution of the first processing task;
determining that the dependent task enable flag indicates that a dependent task should be executed when execution of the first processing task is complete; and
scheduling the dependent task for execution in the multi-threaded system.
